(19) United States
(12) Patent Application Publication
(10) Pub. No.: US 2014/0214450 A1
(43) Pub. Date: Jul. 31, 2014

(54) DATA RECONCILIATION FROM TRUSTED SOURCES

(71) Applicant: ATHENAHEALTH, INC., Watertown, MA (US)

(72) Inventors: Joseph Bechtold, Cambridge, MA (US); Jessica Blevins, Brighton, MA (US); Steven Kelch, Cambridge, MA (US); Neil Dowgun, Arlington, MA (US); Luis Gutierrez, Boston, MA (US); Leah Haas, Brighton, MA (US); Kristen McCarthy, Southborough, MA (US); Christopher Papazian, Cambridge, MA (US); Takeshi Toyohara, Lincoln, MA (US); Michelle Vincow, Somerville, MA (US)

(73) Assignee: athenahealth, Inc., Watertown, MA (US)

(21) Appl. No.: 13/754,786

(22) Filed: Jan. 30, 2013

(51) Int. Cl. G06F 19/00; G06Q 50/22

(52) U.S. Cl. CPC G06F 19/322; G06Q 50/22
USPC 705/3

(57) ABSTRACT

Methods and apparatus for reconciling clinical data received from an external source with patient data stored by a practice management system are described. Clinical data received from a source external to a healthcare information management component of the practice management system are evaluated to determine whether the received clinical data includes trusted source data. The determination is made based, at least in part, on at least one trusted source rule stored by the practice management system. The trusted source data is automatically reconciled with the patient data stored by the practice management system by performing a reconciliation action based on the at least one trusted source rule stored by the practice management system.

### BACKGROUND

Maintaining medical information for patients of a medical practice is important to facilitate the care of patients by providing physicians at the medical practice with an accurate representation of a patient's health history including, among other things, allergies, medications, surgical history, and vaccinations. In some conventional medical information systems used by medical practices, each patient of the medical practice is associated with a paper-based chart maintained at the medical practice and the paper-based chart is consulted and updated when the patient visits the medical practice.

With the advent of electronic medical records (EMRs—also known as electronic health records (EHRs)), medical information for a patient may instead be stored electronically using computer-based systems. EHR systems may include user interfaces that enable healthcare professionals to enter and access the stored medical information during a patient visit. Although the medical information for patients may be stored electronically in an EHR system, information from external sources (e.g., laboratories, immunization registries, etc.) may use paper-based records, and this information may be manually entered into the EHR system via a user interface provided by EHR system.

Some medical practices contract with third-party providers of a practice management system to manage EHRs for patients of the medical practice. For example, information related to patient visits, lab results, current medications, among other things, may be stored by the practice management system and this information may be made available to physicians or other staff at a medical practice though a network-based system in order to facilitate patient care.

### SUMMARY

The inventors have recognized and appreciated that manual reconciliation of data provided by sources external to an EHR system with stored patient data is a time consuming process that often requires substantial resources on the part of the medical practice. To this end, some embodiments of the invention are directed to methods and apparatus for facilitating the reconciliation of data from an external source with patient data stored by a practice management system that includes an EHR component.

Some embodiments are directed to a method of reconciling clinical data received from an external source with patient data stored by a practice management system, the method comprising: receiving the clinical data; determining, by at least one processor, whether the received clinical data includes trusted source data, wherein the determination is made based, at least in part, on at least one trusted source rule stored by the practice management system; and automatically reconciling the trusted source data with the patient data stored by the practice management system by performing a reconciliation action based on the at least one trusted source rule stored by the practice management system.

Some embodiments are directed to a computer system including at least one server computer configured to host a practice management system. The at least one computer comprises: at least one storage device configured to store a plurality of trusted source rules; and at least one processor programmed to: receive clinical data; determine whether the received clinical data includes trusted source data, wherein the determination is made based, at least in part, on at least one of the plurality of trusted source rules; and automatically reconcile the trusted source data with the patient data stored by the practice management system by performing a reconciliation action based on the at least one of the plurality of trusted source rules.

Some embodiments are directed to at least one computer-readable medium encoded with a plurality of instructions that, when executed by at least one computer configured to host a practice management system, perform a method, comprising: receiving the clinical data; determining whether the received clinical data includes trusted source data, wherein the determination is made based, at least in part, on at least one trusted source rule stored by the practice management system; and automatically reconciling the trusted source data with patient data stored by the practice management system by performing a reconciliation action based on the at least one trusted source rule stored by the practice management system.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic of a practice management system for use with some embodiments of the invention;

FIG. 2 is a schematic of a health information management component of a practice management system for use with some embodiments of the invention;

FIG. 3 is a flow chart of a process for reconciling clinical data from an external source in accordance with some embodiments of the invention;

FIG. 4 is a portion of a user interface for configuring trusted source rules in accordance with some embodiments of the invention;

FIG. 5 is a portion of a user interface for displaying results of an automatic data reconciliation process in accordance with some embodiments of the invention; and

FIG. 6 is a schematic of an illustrative computer system on which some embodiments of the invention may be employed.

### DETAILED DESCRIPTION

The present disclosure generally relates to inventive methods and apparatus for managing data in a practice management system, and more specifically relates to reconciling data from an external source with stored patient data, wherein the reconciliation is based, at least in part, on a plurality of rules stored by the practice management system. Automating at least a portion of a data reconciliation process for medical information stored by a practice management system enables a medical practice to focus their resources on treating patients rather than managing the entry and storage of medical information.

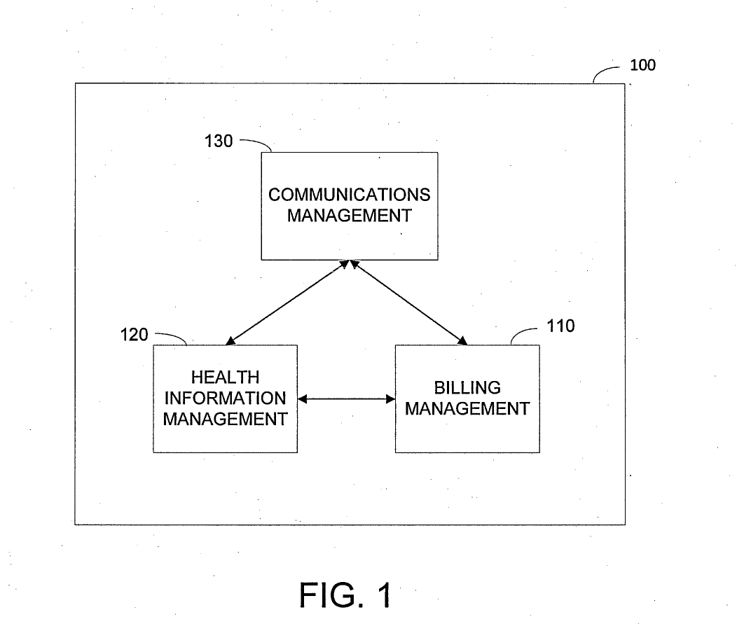

A block diagram of a practice management system in accordance with some embodiments of the invention is shown in FIG. 1. Practice management system 100 may be a networked system that includes a plurality of components configured to perform tasks related to specific functions within the practice management system to facilitate the management of various aspects of medical practices including, billing, managing health information, and communications with patients.

Exemplary practice management system 100 includes health information management component 120, which is configured to store electronic health information for patients at medical practices including, but not limited to, electronic medical records, lab results, imaging results, and pay for performance requirements related to patients of the medical practice. Health information management component 120 may include one or more processors programmed to manage the electronic health information stored thereon, as discussed in more detail below. For example, one or more processors associated with health information management component 120 may be programmed to reconcile data received from an external source with electronic health information stored by health information management component 120.

Practice management system 100 also includes billing management component 110, which is configured to facilitate the collection, submission, and tracking of claims filed by the medical practice to a plurality of payers (including patients) to ensure that the medical practice is properly compensated for medical services rendered to patients treated at the medical practice.

Exemplary practice management system 100 also includes communications management component 130, which interacts with health information management component 120 and billing management component 110 to facilitate interactions with patients on behalf of the medical practice using a communications channel including, but not limited to, text-based communications, web-based communications, and phone-based communications. In some embodiments, communications management component 130 may include a web-based portal implemented as a portion of a web application, with which patients may interact to perform a plurality of actions associated with services at a medical practice including, but not limited to, registering to be a new patient at a medical practice, providing a third party with access to interact with the medical practice, secure messaging of protected health information (PHI) with authorized medical personnel, submitting electronic payment information for medical bills, accessing educational content, completing medical forms, and receiving directions to the medical practice.

Although practice management system 100 is only shown as having three components, it should be appreciated that practice management system 100 may include any number of components (including less than three components) that interact in any suitable way, as embodiments are not limited in this respect. Furthermore, some or all of the components in practice management system 100 may interact by sharing data, triggering actions to be performed by other components, prevent actions from being performed by other components, storing data on behalf of other components, and/or interacting in any other suitable way.

In some embodiments, healthcare information management component 120 of a practice management system may be configured to receive clinical data from one or more sources external to the healthcare information management component 120, and at least some of the received clinical data may be compared to patient data stored by the healthcare information management component 120. For example, as discussed in further detail below, clinical data may be received from sources including, but not limited to, an immunization registry, a pharmacy, a laboratory, an imaging center, and a web-based portal provided by a communications management component of the practice management system.

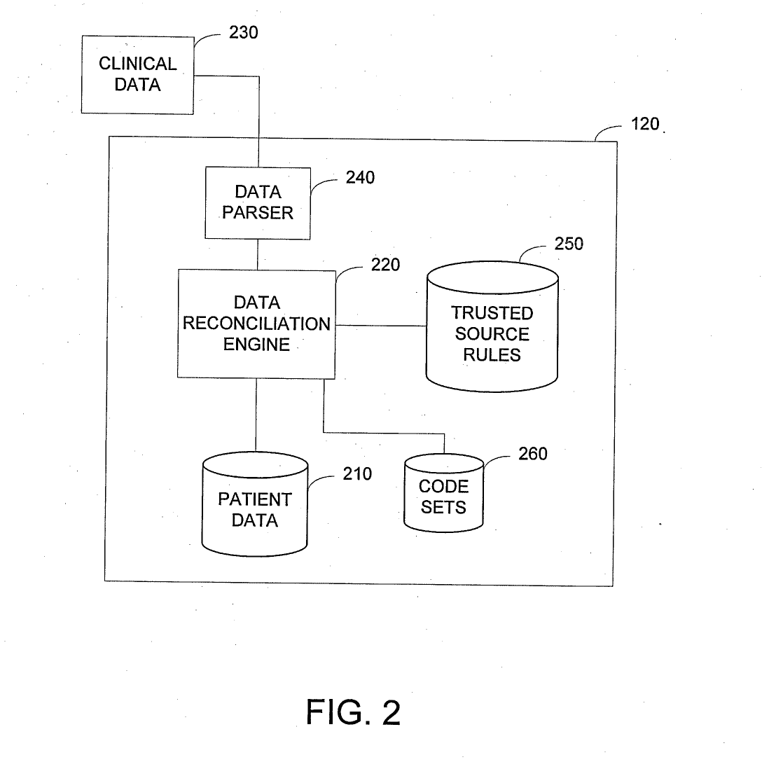

FIG. 2 is a block diagram of an illustrative implementation of a healthcare information management component 120 in accordance with some embodiments of the invention. Healthcare information management component 120 includes one or more datastores configured to store patient data 210 on the practice management system. In some embodiments, patient data 210 may be stored as structured data implemented as an electronic clinical chart for patients of a medical practice associated with the practice management system. The patient data 210 may be structured in any suitable way, as the techniques described herein are not limited by the manner in which the patient data 210 is stored.

Healthcare information management component 120 may also include a data reconciliation engine 220 configured to process incoming clinical data 230 received from a source external to the healthcare information management component 120. Depending on the format of the received clinical data, the clinical data may first be mapped to elements that may be processed by the data reconciliation engine 220 prior to a data reconciliation process. However, not all embodiments are so limited, as the received clinical data 230 may be in a format that does not require mapping. In some embodiments that include a mapping component, healthcare information management component 120 may additionally include data parser 240 that parses the incoming clinical data 230 to map the clinical data 230 to provide structured clinical data. The data reconciliation engine 220 may proceed to compare the structured clinical data to the patient data 210 stored by the practice management system. As discussed above, it should be appreciated that not all implementations include data parser 240, as some implementations may require that clinical data 230 received from an external source be in a structured data format that the data reconciliation engine is capable of processing directly without mapping of the data. Additionally, some clinical data 230 may be received from other components of the practice management system (e.g., communications management component 130) and such clinical data 230 may not require additional parsing by data parser 240 prior to being processed by the data reconciliation engine 220. The extent to which clinical data received from an external source is parsed by healthcare information management component 120 does not limit the techniques described herein, as any suitable amount of parsing may be used.

In some conventional EHR systems, clinical data received from an external source is typically manually input into the EHR system by a user at a medical practice, and any discrepancies between the received clinical data and data already stored in a patient's clinical record are resolved by the user inputting the data. The inventors have recognized that a factor preventing widespread adoption of automatic reconciliation of incoming clinical data into a patient's electronically-stored clinical chart is ensuring the accuracy of the patient data stored by the practice management system. For example, healthcare providers may be concerned that if all received clinical data is used to replace the patient data stored in the practice management system, errors in the received clinical data may propagate into the stored patient data. To reduce the amount of errors introduced into the EHR, some conventional EHR systems require all data received from an external source to be manually entered into electronic health records stored by the practice management system, as discussed above.

Appreciating that prior approaches to data reconciliation are neither particularly effective nor efficient solutions for healthcare providers, some embodiments are directed to providing a middle ground where the data reconciliation engine 220 may be configured to identify clinical data received from particular “trusted sources” as being reliable enough to be automatically transferred into a patient's medical chart without user intervention, while clinical data received from a source that is not a trusted source is flagged for manual data entry. Accordingly, in some embodiments, healthcare information management component 120 may include one or more datastores configured to store a plurality of trusted source rules 250 that describe which received clinical data is allowed to propagate into the patient data 210. The plurality of trusted source rules 250 may also instruct data reconciliation engine 220 how to determine which reconciliation actions to take on particular clinical data that is received by the healthcare information management component 120, as discussed in further detail below.

Healthcare information management component 120 may also include one or more datastores configured to store code sets 260 that facilitate the reconciliation of clinical data 230 by data reconciliation engine 220. Code sets 260 may describe standardized nomenclatures for identifying clinical elements in clinical documents. In some embodiments, code sets 260 may include code sets for different types or categories of clinical information including, but not limited to, medications, allergies, and immunizations. In some embodiments, code sets 260 may be used to match received clinical data 230 to patient data 210 stored by the practice management system. Exemplary code sets 260 for use with some embodiments of the invention are illustrated in Table 1.

TABLE 1
Exemplary Code Sets

| Clinical | |
|---|---|
| Data Type | Code Set |
| Medications | NDC, RxNorm ID, FDB Med ID, FDB Med Name ID |
| Allergy | RxNorm, FDB Med Name, FDB HIC sequence number, |
| | FDB DAM ALRGN GRP, UNII |
| Immunization | CVX, CPT |
| Problems | ICD-9, SNOMED |

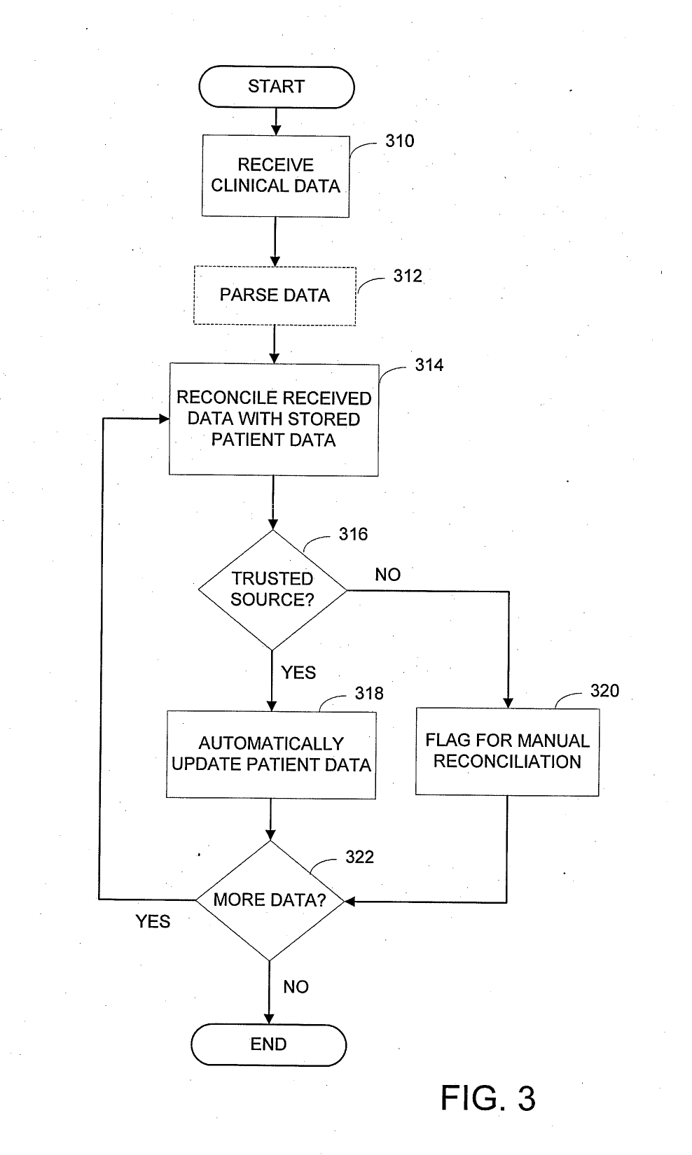

FIG. 3 is a flow chart of an illustrative process for reconciling clinical data received from an external source with patient data stored by a practice management system. In act 310, clinical data is received from an external source. As discussed above, the clinical data may be received from another component within the practice management system or the clinical data may be received from a source external to the practice management system via a network interface. Illustrative external sources include, but are not limited to, a web-based portal form provided by a communications management component of the practice management system, an immunization registry, a network-connected source such as a laboratory, prescription service, pharmacy, imaging center that provides information in HL7 format, or Health Information Exchanges and clinicians that provide a continuity-of-care document (CCD), and a paper-based medical chart that has been converted to an electronic format.

After receiving the clinical data from the external source, the process proceeds to act 312, where the received clinical data is optionally parsed prior to providing the data to the data reconciliation engine for processing. As discussed above, some embodiments may be configured to parse at least some received clinical data to map the received clinical data to a structured data format that the data reconciliation engine can process and compare with the stored patient data. At least some received clinical data may already be in a structured data format that the data reconciliation engine can process without parsing. In some embodiments, information included in one or more code sets stored by the healthcare information management component may be used by a data parser to map the received clinical data to data elements which the data reconciliation engine can process. The extent to which data is parsed does not limit techniques described herein.

The process then proceeds to act 314, where the received clinical data is reconciled with patient data stored by the practice management system. In some embodiments, the received clinical data is processed by comparing data elements in the received clinical data to stored patient data elements. The received clinical data may be compared with the stored patient data in any suitable way. For example, in some embodiments, the data reconciliation engine is configured to apply one or more rules to determine whether to replace at least some of the stored patient data, if present, with the received clinical data. Exemplary rules for reconciling received clinical data with stored patient data are described in more detail below.

In some embodiments, at least some of the rules applied by the data reconciliation engine may be based, at least in part, on a source of the received clinical data. For example, a user of the practice management system may specify one or more sources of clinical data as “trusted sources,” and clinical data received from a trusted source may be processed by data reconciliation engine in accordance with one or more trusted source rules associated with the trusted source. Accordingly, the process proceeds to act 316, where it is determined whether the received clinical data is from a trusted source. In some embodiments, the healthcare information management component of the practice management system may be configured to enable each medical practice to specify the source(s) of clinical data to treat as trusted sources. Alternatively or additionally, an administrator of the practice management system may designate one or more sources as being trusted sources. For example, in some embodiments, a web-based portal provided by a communications management component of the practice management system may always be designated as a trusted source. Embodiments are not limited by which external sources are designated as trusted sources, and any suitable configuration may be used.

The determination of whether the received clinical data is from a trusted source may be made in any suitable way. For example, metadata associated with the received clinical data may indicate the source of the data and the source of the data may be checked against a trusted source configuration file stored by the practice management system for a medical practice. In some embodiments, after the source of the received clinical data is determined, it may be determined if there is at least one trusted source rule that applies to clinical data received from the trusted source. Alternatively, the existence of at least one trusted source rule may itself be evidence that the source of the clinical data is configured as a trusted source.

If it is determined in act 316 that the data is from a trusted source, the process proceeds to act 318, where the received clinical data is used to update patient data stored by the practice management system in accordance with one or more trusted source rules associated with the trusted source, as discussed in more detail below. If it is determined that the received clinical data is not from a trusted source, the process proceeds to act 320, where the received clinical data is flagged for data reconciliation by a user of a medical practice. In some embodiments, some types of clinical data received from a trusted source may be used to update patient data, while other types of clinical data received from the trusted source may be flagged for data reconciliation by a user of a medical practice. The extent to which data reconciliation is automated does not limit the techniques described herein.

The process then proceeds to act 322, where it is determined whether there is additional received clinical data to reconcile. If it is determined that there is additional clinical data, the process returns to act 314, where the additional clinical data is reconciled, as discussed above. Otherwise, if it is determined in act 322 that there is no additional clinical data to reconcile, the process ends.

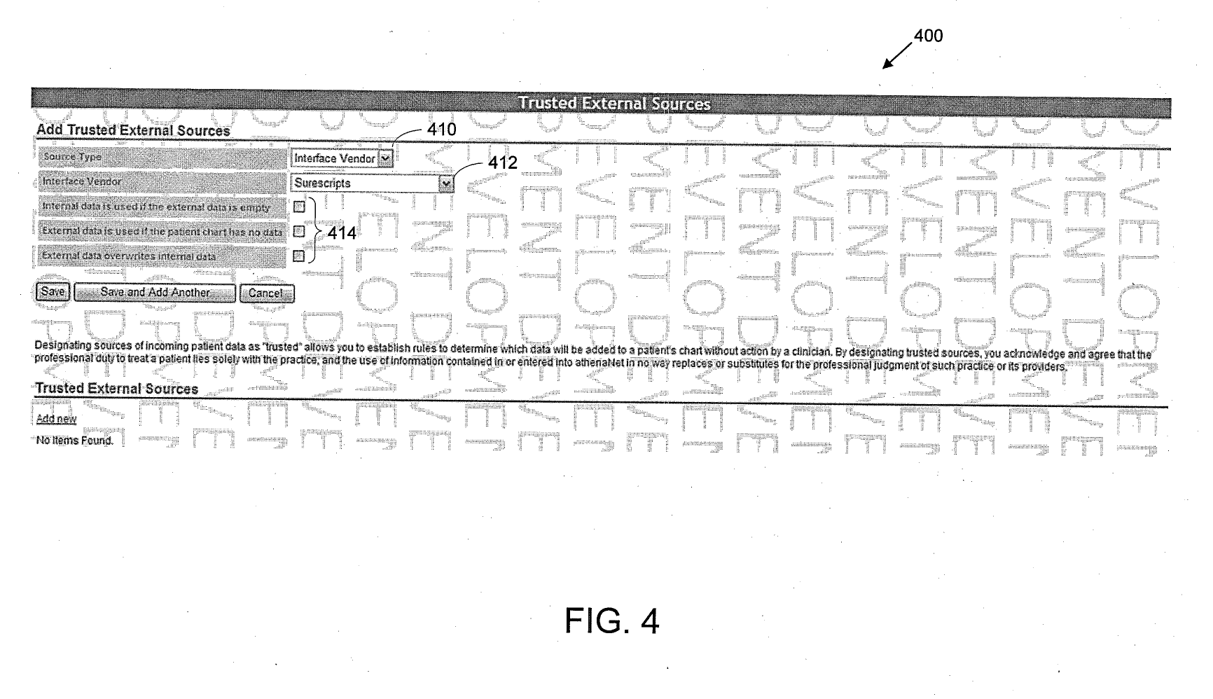

FIG. 4 is a schematic of an illustrative trusted source configuration page 400 of a user interface provided by a healthcare information management component of a practice management system in accordance with some embodiments of the invention. A user of a practice management system may interact with trusted source configuration page 400 to designate one or more sources of clinical data as trusted sources. Trusted source configuration page 400 includes source type selector 410 that enables a user to select a type of source to designate as a trusted source. Exemplary source types include, but are not limited to, interface vendors, such as an immunization registry or a laboratory, or a web-based portal provided by the practice management system.

Trusted source configuration page 400 also includes source identifier selector 412 that enables a user to select a particular source having the source type identified by a user selection of the source type selector 410. A source type may identify a particular category of external source and selection of a source type may filter a list of all possible sources to facilitate a user selection. For example, if source type selector 410 is set to “Interface Vendor,” a list of interface vendors supported by the practice management system may be displayed for selection using source identifier selector 412. Exemplary interface vendors include, but are not limited to, immunization registries, laboratories, prescription vendors, pharmacies, and imaging centers. Alternatively, if source type selector 410 is set to “Other,” a list of other types of external sources including, but not limited to, a web-based portal provided by the practice management system may be displayed for selection using source identifier selector 412. Source types other than “Interface Vendor” and “Other” may also be used and the techniques described herein are not limited in this respect. In some embodiments, a source type selector may not be displayed and a user may select a source from a list of all compatible sources or the complete list may be filtered in some other way other than source type.

Trusted source configuration page 400 also includes a plurality of user-selectable trusted source rules 414 that a user may select to configure the reconciliation behavior of data reconciliation engine in response to receiving clinical data from the trusted source selected using source identifier selector 412. As discussed above, the data reconciliation engine may map received clinical data to stored patient data and make a comparison between the received data and the stored data. One or more trusted source rules stored by one or more datastores associated with the practice management system and configured by a user at a medical practice may instruct the data reconciliation engine to perform one or more reconciliation actions to reconcile the received data from a trusted source with the stored patient data.

In some embodiments, at least some data elements in the received clinical data may include a primary element and one or more sub-elements that describe the type of information included in the data element. The primary element may represent a code set level identifier identifying the data element within a particular code set. For example, a data element for a Diphtheria, Tetanus, and Pertussis (DTaP) vaccine may include a primary element corresponding to a CVX code of 20 or a CPT code of 90700 corresponding to this vaccine's value in the CVX and CPT code sets. Data elements may also include one or more sub-elements that provide additional information about the received clinical data. For example, the data element for the DTaP vaccine may also include a first sub-element for the lot number of the vaccine and a second sub-element for the manufacturer of the vaccine. The techniques described herein are not limited by the number or type of elements or sub-elements specified in the received clinical data or the patient data stored by the practice management system.

As discussed above, a portion of the reconciliation process may be to identify matching data elements between the received clinical data and the patient data (e.g., the patient's clinical chart) stored by the practice management system. The matching process may be performed based, at least in part, on similar primary elements and/or sub-elements identified between the received clinical data and the stored patient data. For example, if the received clinical data includes a data element having a primary element with a CVX code of 20, a data element with the corresponding CVX code of 20 may be searched for in the patient's stored data.

The data reconciliation engine may determine that there is no match, there is a match, or there is a potential match. A “no match” condition may result from the lack of a corresponding data element in either the received clinical data or the stored patient data. FIG. 4 illustrates three exemplary trusted source rules 414 that may be configured by a user of a medical practice in accordance with some embodiments of the invention, although it should be appreciated that any number of trusted source rules, including only a single trusted source rule, may be used, as the techniques described herein are not limited in this respect.

The first two illustrative rules shown in FIG. 4 relate to the “no-match” condition discussed above, when either a data element is present in the received clinical data and not in the stored patient data, or vice versa. The first illustrative rule relates to the case where there is no corresponding received clinical data that matches a data element in the stored patient data, with the corresponding reconciliation action being to retain the stored patient data. The second illustrative rule relates to the opposite case where a data element in the received clinical data does not match any data elements in the stored patient data, with the corresponding reconciliation being to automatically add the received data element to the stored patient data.

FIG. 4 also illustrates a third illustrative rule related to the “match” condition, discussed above. According to this rule, when a data element in the clinical data received from a trusted source matches a data element in the stored patient data, the corresponding reconciliation action is to replace the stored patient data with the received clinical data. For this illustrative rule, it is assumed that the data received from the trusted source is more likely to be correct and should be propagated into the patient's clinical record. In some embodiments, modifications and/or additions to a patient's electronically-stored clinical record may be noted by the practice management system to indicate that the data has been automatically updated in accordance with at least one trusted source rule as described herein. This indication may take any suitable form including, but not limited to, associating metadata with stored patient data that has been automatically reconciled based on a trusted source rule.

Although not expressly illustrated in FIG. 4, at least some trusted source rules may be based on identifying a possible match between data elements in the received clinical data and the stored patient data. For example, a received data element and a stored data element may have the same primary element, but may differ with respect to the number and/or type of sub-elements. Continuing with the illustrative DTaP vaccine example discussed above, both the received clinical data and the stored patient data may include data elements with a primary element indicating a CVX value of 20 corresponding to the vaccine. However, the received data element may also include sub-elements for lot number (e.g., lot 1123) and manufacturer (e.g., Merck), whereas the stored patient data may not include any sub-elements or may only include a sub-element for lot number, but not manufacturer. In one implementation, a trusted source rule may be configured to trigger a reconciliation action to add the additional-information included in the sub-elements of the received data element to the stored patient data when the received data element is from a trusted source and includes more sub-elements than are present in the stored patient data.

In another implementation, a trusted source rule may specify that additional data received from a trusted source is always used to replace patient data stored by the practice management system regardless of whether the received clinical data includes more sub-elements than the stored patient data. In yet another implementation, a trusted source rule may specify that additional sub-element information in the received data element is added to the stored patient data, but sub-elements that are already stored in the patient data are not replaced with the received clinical data element. In yet another implementation, a trusted source rule may relate to a case where a received data element and a corresponding stored patient data element have sub-elements in common with the same value, but the received data element has fewer sub-elements overall. In this case, the trusted source rule may determine that the received data element is a duplicate, the received data element may be ignored, and the stored data element may be maintained without modification. As should be appreciated from the foregoing, depending on a user's level of trust of the accuracy of information from a trusted source, embodiments of the invention may be configured with trusted source rules to provide more or less automatic propagation of received clinical data into a patient's electronic health record stored by a practice management system.

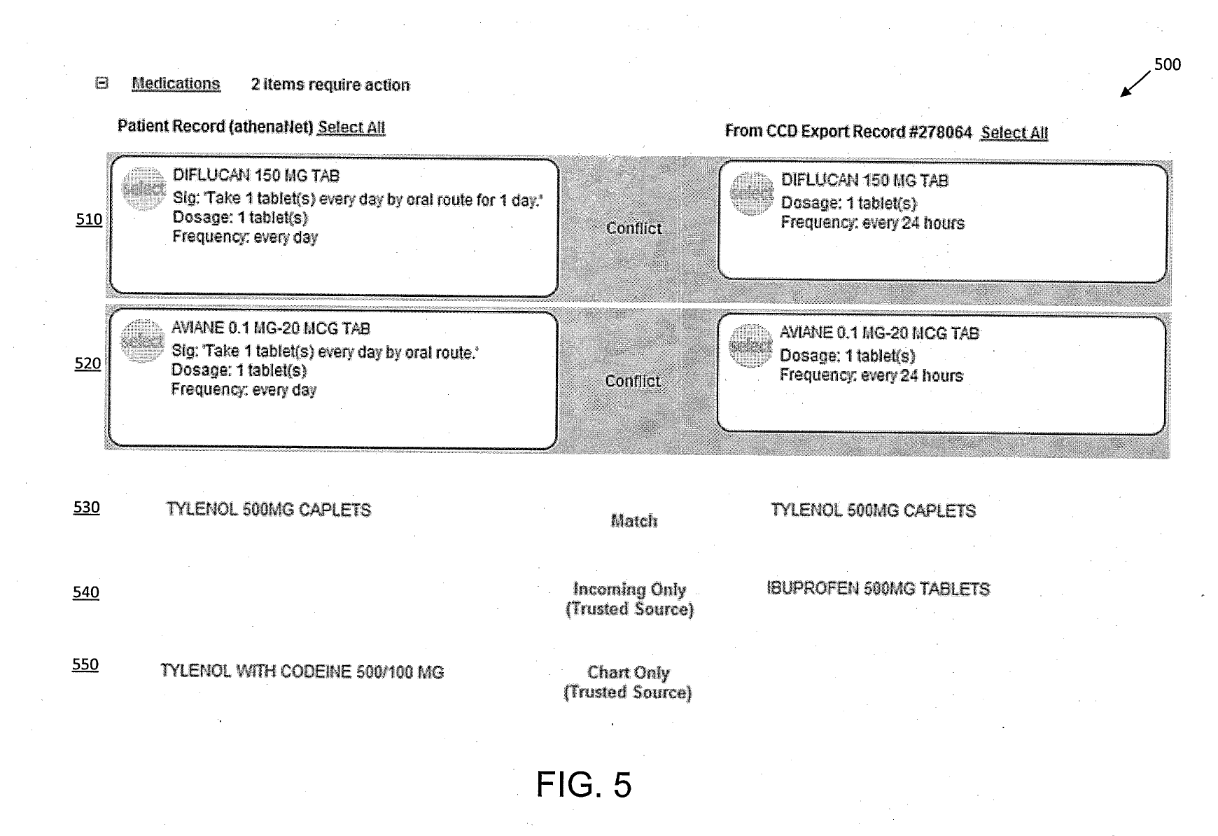

In some embodiments, the health information management component of a practice management system may include one or more trusted source rules for determining that a received clinical data element is a potential match to stored patient data, even if there is not an exact match of some aspect of the data elements. For example, if a received clinical data element indicates an immunization was performed on a patient on a different day, but within the same year as the stored patient data for that patient indicates the immunization was performed, a trusted source rule may be configured to determine that these data elements likely relate to the same immunization, and accordingly, there is a potential match for which the received clinical data element should replace the stored patient data element. Alternatively, the stored patient data may not automatically be replaced with the received clinical data element, but the potential match may be flagged and presented to a user for manual data reconciliation, as discussed below in connection with FIG. 5. Although received clinical data from an immunization registry is discussed above, it should be appreciated that other types of received clinical data may also be determined to be potential matches to stored patient data. For example, procedures that occur within the same month or year may be considered as potential matches in one implementation.

In some embodiments, the data reconciliation engine may perform a reconciliation action (e.g., adding, replacing, modifying patient data) in response to applying one or more trusted source rules, and the reconciliation action to be performed may be determined based, at least in part, on criteria associated with the data elements being compared. For example, an action performed in response to applying a trusted source rule may be determined based, at least in part, on criteria including, but not limited to, a type of health information for the data element.

FIG. 5 illustrates an exemplary reconciliation page 500, which shows a result of applying one or more trusted source rules to received clinical data. In FIG. 5, the received clinical data was a continuity of care document (CCD) received by the data reconciliation engine and the received clinical data was compared to patient data stored by the practice management system. The received CCD included clinical data for medications taken by the patient. Based on the received clinical data, five data elements were determined to be relevant for reconciliation between the received clinical data and the stored patient data for the patient. Data element pairs 510 and 520 were determined to have conflicting information between the received clinical data and the stored patient data, and these data pairs were flagged for manual data reconciliation. Data element pair 530 was determined to have identical data for the received and stored data, and is thus indicated as a match (i.e., a duplicate), with no change to the stored patient data. Data element 540 was present only in the received CCD clinical data but not in the stored patient record, and data element 550 was present only in the stored patient data but not in the received clinical data. After matching the data elements from the received clinical data and the stored patient data, one or more trusted source rules may be applied to the data elements, as discussed above. For received data elements that involve conflicts with stored patient data, and for which a trusted source rule is not configured to automatically resolve the conflict, the data elements may be manually reconciled by a user in accordance with procedures known to those of skill in the art and as previously described above (e.g., manually entering the received clinical data, if desired).

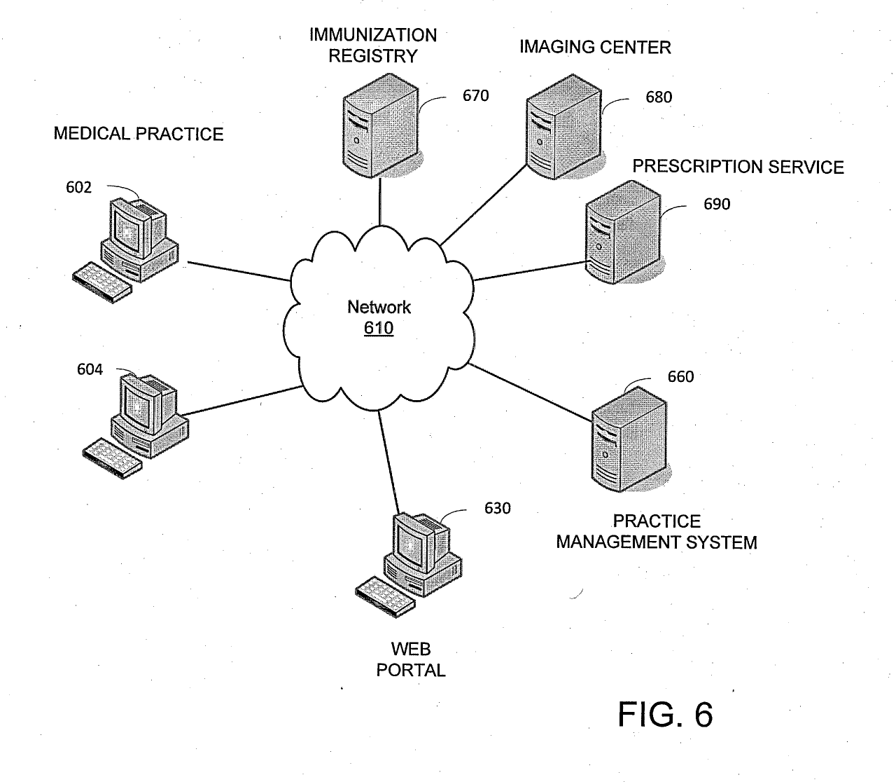

FIG. 6 illustrates an exemplary networked system on which some embodiments of the invention may be employed. Networked computers 602 and 604 located at a medical practice, web portal client computer 630, and computer 660 located at a location associated with a practice management system are shown connected to a network 610. Additionally, external sources including immunization registry 670, imaging center 680, and prescription service 690 are also shown connected to a network 610. Each of the one or more computers connected to network 610 may include one or more communications interfaces that enable the computer to communicate information to and/or receive information from one or more other computers connected to the network. For example, in some embodiments, a communications interface may include a health information management interface that enables computer 660 to receive clinical data from a health information management server also connected to network 610.

Network 610 may be any type of local or remote network including, for example, a local area network (LAN) or a wide area network (WAN) such as the Internet. In the example of FIG. 6, two networked computers at a medical practice, one web portal client computer, and three external sources of clinical data are shown. However, it should be appreciated that network 610 may interconnect any number of computers of various types and the networked system of FIG. 6 is provided merely for illustrative purposes. For example, computer 660 may be connected via network 610 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration. Additionally, one or more of the computers in the networked system may be protected from unauthorized access using any suitable security protection devices or processes including, but not limited to, firewalls, data encryption, and password-protected storage.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a tablet computer, a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form as discussed above in connection with FIG. 6, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The tangible computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method of processing data in a practice management system, the method comprising:
receiving clinical data;
determining, by at least one processor, whether the received clinical data includes trusted source data; and
in response to determining that the received clinical data includes trusted source data, automatically reconciling the trusted source data with patient data stored by the practice management system by performing a reconciliation action based on at least one trusted source rule stored by the practice management system.

2. The method of claim 1, wherein the at least one trusted source rule specifies a type of the clinical data and/or a source of the clinical data.

3. The method of claim 1, wherein the automatically reconciling the trusted source data with the patient data comprises:
determining which data elements of the trusted source data match or potentially match data elements of the stored patient data to produce data element pairs; and
applying the at least one trusted source rule to the data element pairs.

4. The method of claim 3, wherein at least one of the data element pairs includes a missing element corresponding to the received clinical data or the stored patient data.

5. The method of claim 1, wherein the performing a reconciliation action comprises replacing the patient data stored by the practice management system with the trusted source data.

6. The method of claim 1, wherein the performing a reconciliation action comprises ignoring the trusted source data and maintaining the patient data stored by the practice management system.

7. The method of claim 1, further comprising:
determining whether the received clinical data is formatted as structured data to which the at least one trusted source rule may be applied;
in response to determining that the received clinical data is not formatted as structured data to which the at least one trusted source rule may be applied, parsing the received clinical data to produce structured clinical data to which the at least one trusted source rule may be applied; and
wherein the determining whether the received clinical data includes trusted source data comprises determining whether the structured clinical data includes trusted source data.

8. The method of claim 7, wherein the parsing the received clinical data to produce structured clinical data comprises mapping information in the received clinical data to a set of data element identifiers specified by the practice management system.

9. The method of claim 1, wherein the receiving the clinical data comprises identifying a form stored by the practice management system, wherein the form includes data input from a patient using a web-based portal provided by the practice management system.

10. The method of claim 1, wherein the receiving the clinical data comprises receiving information from an immunization registry, prescription service, or medication database.

11. The method of claim 1, further comprising;
selecting a set of trusted source rules based, at least in part, on a type of the received clinical data; and
wherein the performing the reconciliation action comprises performing the reconciliation action based on at least one rule in the set of trusted source rules.

12. A computer system including at least one computer configured to host a practice management system, the at least one computer comprising:
a communications interface configured to receive clinical data;
at least one storage device configured to store a plurality of trusted source rules; and
at least one processor programmed to:
determine whether the received clinical data includes trusted source data; and
in response to determining that the received clinical data includes trusted source data, automatically reconcile the trusted source data with patient data stored by the practice management system by performing a reconciliation action based on at least one trusted source rule stored by the practice management system.

13. The computer system of claim 12, wherein the automatically reconciling the trusted source data with the patient data comprises:
determining which data elements of the trusted source data match or potentially match data elements of the stored patient data to produce data element pairs; and
applying the at least one of the plurality of trusted source rules to the data element pairs.

14. The computer system of claim 13, wherein at least one of the data element pairs includes a missing element corresponding to the received clinical data or the stored patient data.

15. The computer system of claim 13, wherein the performing a reconciliation action comprises replacing the patient data stored by the practice management system with the trusted source data or ignoring the trusted source data and maintaining the patient data stored by the practice management system.

16. The computer system of claim 13, wherein the at least one processor is further programmed to:
determine whether the received clinical data is formatted as structured data to which the at least one trusted source rule may be applied;
in response to determining that the received clinical data is not formatted as structured data to which the at least one trusted source rule may be applied, parse the received clinical data to produce structured clinical data to which the at least one trusted source rule may be applied; and
wherein the determining whether the received clinical data includes trusted source data comprises determining whether the structured clinical data includes trusted source data.

17. The computer system of claim 16, wherein the parsing the received clinical data to produce structured clinical data comprises mapping information in the received clinical data to a set of data element identifiers specified by the practice management system.

18. The computer system of claim 12, wherein the receiving the clinical data comprises identifying a form stored by the practice management system, wherein the form includes data input from a patient using a web-based portal provided by the practice management system.

19. At least one computer-readable medium encoded with a plurality of instructions that, when executed by at least one computer configured to host a practice, management system, perform a method, comprising:
receiving clinical data;
determining whether the received clinical data includes trusted source data; and
in response to determining that the received clinical data includes trusted source data, automatically reconciling the trusted source data with patient data stored by the practice management system by performing a reconciliation action based on at least one trusted source rule stored by the practice management system.

20. The at least one computer-readable medium of claim 19, wherein the automatically reconciling the trusted source data with the patient data comprises:
determining which data elements of the trusted source data match or potentially match data elements of the stored patient data to produce data element pairs; and
applying the at least one trusted source rule to the data element pairs.

21. The at least one computer-readable medium of claim 19, wherein the performing a reconciliation action comprises replacing the patient data stored by the practice management system with the trusted source data or ignoring the trusted source data and maintaining the patient data stored by the practice management system.

22. The at least one computer-readable medium of claim 19, wherein the method further comprises:
determining whether the received clinical data is formatted as structured data to which the at least one trusted source rule may be applied;
in response to determining that the received clinical data is not formatted as structured data to which the at least one trusted source rule may be applied, parsing the received clinical data to produce structured clinical data to which the at least one trusted source rule may be applied; and
wherein determining whether the received clinical data includes trusted source data comprises determining whether the structured clinical data includes trusted source data.

23. The at least one computer-readable medium of claim 22, wherein the parsing the received clinical data to produce structured clinical data comprises mapping information in the received clinical data to a set of data element identifiers specified by the practice management system.

24. The at least one computer-readable medium of claim 19, wherein the receiving the clinical data comprises identifying a form stored by the practice management system, wherein the form includes data input from a patient using a web-based portal provided by the practice management system.

25. The at least one computer-readable medium of claim 19, wherein the receiving the clinical data comprises receiving information from an immunization registry, prescription service, or medication database.
